(19) United States
(12) Patent Application Publication
(10) Pub. No.: US 2026/0126397 A1
(43) Pub. Date: May 7, 2026

(54) SYSTEM FOR TESTING THE CHARACTERISTICS OF PRECIOUS STONES

(71) Applicant: ETA SA Manufacture Horlogère Suisse, Grenchen (CH)

(72) Inventor: Dominique DUBUGNON, Saint-Prex (CH)

(73) Assignee: ETA SA Manufacture Horlogère Suisse, Grenchen (CH)

(21) Appl. No.: 19/360,217

(22) Filed: Oct. 16, 2025

(30) Foreign Application Priority Data
Nov. 4, 2024 (EP) 24210632.6

(51) Int. Cl. G01N 21/87

(52) U.S. Cl. CPC G01N 21/87; G01N 2201/0634; G01N 2201/0636

(57) ABSTRACT

A device (2) for illuminating a precious stone (10), including a light projector (3) equipped with a main lighting module (14a) for generating illumination configured to reveal the characteristics of the precious stone (10), the main module (14a) including a circuit board (25) including a plurality of light sources (16) each emitting a light beam and an optical diffusion element arranged facing the plurality of light sources (16), the main module (14a) including a reflector (21) arranged between the support element (7) and the optical diffusion element, and including at least one cavity capable of reflecting at least part of the light beams towards the optical diffusion element, each cavity being formed by a back (17) and peripheral walls (18a, 18b, 18c) extending from the back (17) towards the optical diffusion element (23), with their respective tops arranged at a first distance (E1) from the optical diffusion element.

### CROSS REFERENCE TO RELATED APPLICATION

This application claims priority to European Patent Application No. 24210632.6 filed Nov. 4, 2024, the entire contents of which are incorporated herein by reference.

### TECHNICAL FIELD OF THE INVENTION

The invention relates to a system for testing the characteristics of a precious stone, comprising a lighting device specifically adapted, in particular, to enable visual identification of the characteristics of such a stone.

### TECHNOLOGICAL BACKGROUND

In the current state of the art, systems for testing the characteristics of precious stones such as diamonds are generally used to verify their authenticity or to classify or otherwise sort these precious stones. To this end, these systems commonly use lighting devices with fluorescent tubes to conduct visual testing of their internal or external characteristics, such as their colour, purity, size or fluorescence.

However, one of the major drawbacks of such systems is that they are not sufficiently safe, as the fluorescent tubes used in these lighting devices comprise substances such as mercury that are harmful to both the environment and human health.

Moreover, these fluorescent tubes are known to produce humming noises, which is an acoustic nuisance likely to disturb the concentration of the operator in charge of identifying these characteristics. Furthermore, these fluorescent tubes can also flicker or flash in a way that is difficult to perceive but that can cause headaches, dizziness, and be problematic for an operator who is light-sensitive or prone to disorders such as epilepsy. Lastly, the arrangement of these fluorescent tubes in these systems does not allow the characteristics of these precious stones to be clearly and repeatedly revealed.

Given these circumstances, there is clearly a need to find a harmless alternative solution.

### SUMMARY OF THE INVENTION

One purpose of the invention is therefore to provide a solution for improving precision when testing the characteristics of precious stones using a system for testing these characteristics that is provided with a lighting device configured to generate illumination of these stones that is precise, dynamic and adaptive.

To this end, one of the aspects of the invention relates to a device for illuminating a precious stone comprising a light projector equipped with a main lighting module for generating illumination specifically configured to reveal the characteristics of the precious stone, said main module comprising a circuit board including a plurality of light sources each emitting a light beam and an optical diffusion element arranged facing said plurality of light sources, said main module (14a) comprising a reflector arranged between said support element and the optical diffusion element, said reflector comprising at least one cavity capable of reflecting at least part of the light beams towards the optical diffusion element, each cavity being formed by a back and peripheral walls extending from the back towards the optical diffusion element, with their respective tops arranged at a first distance from the optical diffusion element.

In other embodiments:
the reflector comprises two cavities capable of reflecting at least part of the light beams towards the optical diffusion element, each cavity being formed by the back, the peripheral walls and a dividing wall separating it from the other cavity, said walls extending from the back towards the optical diffusion element and having their respective tops arranged relative to the optical diffusion element at a first distance for the peripheral walls and a second distance for the dividing wall, the first distance being less than the second distance;
the light sources comprise electroluminescent elements;
the light sources have adjustable colour temperatures that range between 2,500 K and 7,000 K, preferably between 5,700 K and 6,300 K;
the device comprises a module for setting functions performed by the device, this module comprising an organ for controlling these functions and a screen transmitting information relating to these functions;
said functions relate to setting the illumination and temperature of the light sources;
the device comprises an articulated arm comprising first and second parts connected at one of their two ends;
these first and second parts each comprise at least one motor for controlling the horizontal and/or vertical movement of the projector relative to said precious stone;
the device comprises peripheral modules arranged in lateral parts of said projector and configured to attenuate luminous disturbances likely to result from a light source external to the device;

Another of these aspects of the invention relates to a system for testing the characteristics of a precious stone comprising such a lighting device and a support element to which is fastened said device which is configured to generate illumination of a zone of interest comprised on a plate on said support element, said zone of interest 8 comprising said precious stone which can be handled by a user.

### BRIEF DESCRIPTION OF THE FIGURES

The purposes, advantages and features of the invention will be apparent from the following detailed description of the invention, given by way of example and with reference to the following appended figures:

FIG. 1 shows a system for testing the characteristics of precious stones, comprising a lighting device suitable for such stones and a plate to which such a device is fastened, according to one embodiment of the invention;

FIG. 2 shows a light spectrum emitted by the lighting device with a colour temperature comprised between 2,500 K and 7,000 K, according to the invention;

FIG. 3 shows a schematic top view of a main lighting module for generating illumination comprised in a projector on the lighting device comprising a plurality of light sources, according to the invention, and

FIG. 4 shows a cross-sectional view A-A of the main module for generating the illumination illustrated in FIG. 3.

### DETAILED DESCRIPTION OF THE INVENTION

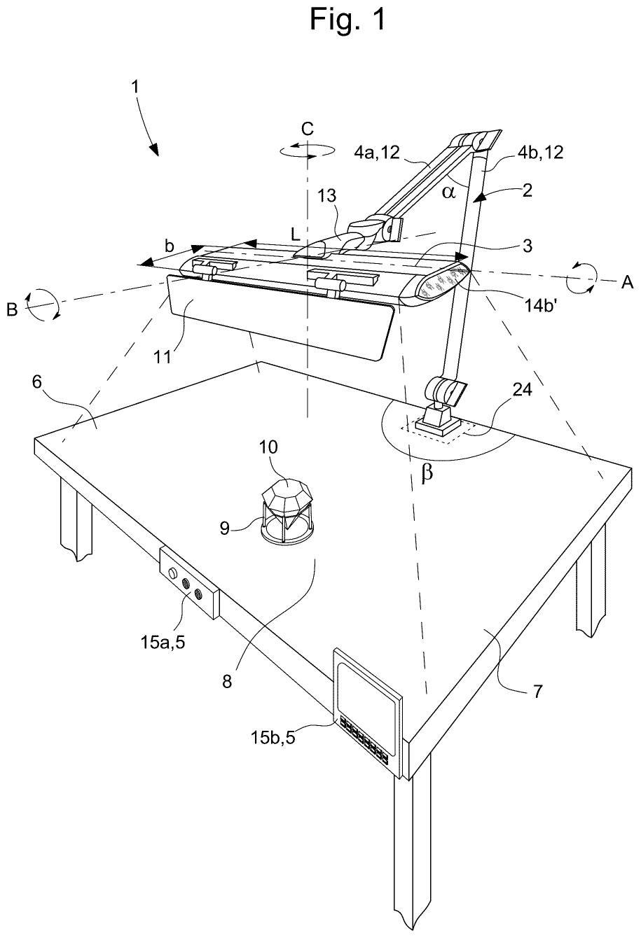

FIG. 1 shows a representation of a system 1 for testing characteristics of a precious stone 10 comprising a lighting device 2 specifically adapted to highlight or differentiate one or more characteristics of precious stones 10. Such a system 1 can be part of a user's work environment. This work environment is preferably set up in a room in a building. In other words, in this room, the only light sources are comprised in the present system 1; otherwise, this room can have a light source such as daylight that is more or less diffuse.

It should be noted that these precious stones 10 include, but are not limited to, gems such as diamonds, sapphires, rubies and emeralds. Additionally, the characteristics, also referred to as properties, of such precious stones 10 can comprise, but are not limited to: their colour, their purity, their size, their fluorescence.

This system 1 comprises a support element 7, such as a desk or a workbench, formed by a plate 6, particularly a rectangular plate. Such a plate 6 comprises, over all or part of its surface, a zone of interest 8 capable of being illuminated by the lighting device 2. This zone of interest 8 comprises a support 9 on which the precious stone 10 with characteristics to be observed can be arranged.

This plate 6 comprises a zone in which the lighting device 2 is fastened to the support element 7.

Such a system 1 helps the user, also referred to as the observer, test the characteristics of the precious stone 10 comprised in the zone of interest 8 with the naked eye, and such testing can include an assessment of these characteristics. In other words, this user performs such a test based on their visual perception of these characteristics of the precious stone 10. This visual perception can be defined as the result of how this user's brain interprets information relating to these characteristics that is comprised in luminous radiation picked up by photoreception and entering through their pupils so as to activate the receptive cells located in the retinas of their eyes. The optic nerve then transmits the signals produced by these cells to the brain.

In this zone of interest 8, the precious stone 10 can be handled by the user. In this system 1, such a zone of interest 8 can be:
a space defined on the plate 6 on the support element 7 when the precious stone 10 is arranged or deposited on the support and thus occupies a portion of the surface of this plate 6, or
a volume defined above this plate 6 and in which this precious stone 10 is comprised when handled by the user.

Such a zone of interest (8) can be specially illuminated according to the user's vision profile and/or to at least one characteristic of the stone.

In this system 1, the lighting device 2 comprises:
a light projector 3;
an articulated arm 12 comprising first and second parts 4a, 4b connected at one of their two ends;
at least one electric motor arranged in the arm 12;
a module 5 for setting functions performed by the device, this module comprising an organ 15a for controlling these functions and a screen 15b transmitting information relating to these functions.

In this device, the arm 12 is designed to connect/fasten/mount this projector 3 to the support element 7 on the system 1 in a fastening/mounting zone 24 defined on the plate 6.

This projector 3 comprises axial or transverse sections, each in the shape of a polygon. Such a projector 3 comprises front and rear parts and two lateral parts.

Such a projector 3 comprises a protective casing, a main lighting module 14a, at least one secondary lighting module 14b, a connector 13 for connecting the projector 3 to the arm 12 of the device 2 and an element 11 for protecting from the light emitted by the projector 3. This protective element 11 protects the user's eyes from the luminous flux that can come from the main lighting module 14a.

In this configuration, the protective element 11 is fastened to the front part of the projector 3 and the connector 13 is fastened to the rear part of the projector 3.

Such a connector is configured to enable the projector 3 to be oriented around at least three axes A, B, C relative to the zone of interest 8 and in particular relative to the precious stone 10 in this zone of interest 8. This projector 3 can also be moved in a vertical direction and/or a horizontal direction relative to the zone of interest 8 and in particular relative to the precious stone 10 in this zone of interest 8. For example, the angle α formed between the first and second parts 4a, 4b of this arm 12 can be varied for a vertical movement and an angle β formed at the zone 24 where the arm 12 is fitted on the plate 6 can be varied for horizontal movement.

This protective casing comprises a chamber in which the main lighting module 14a and said at least one secondary lighting module 14b are arranged.

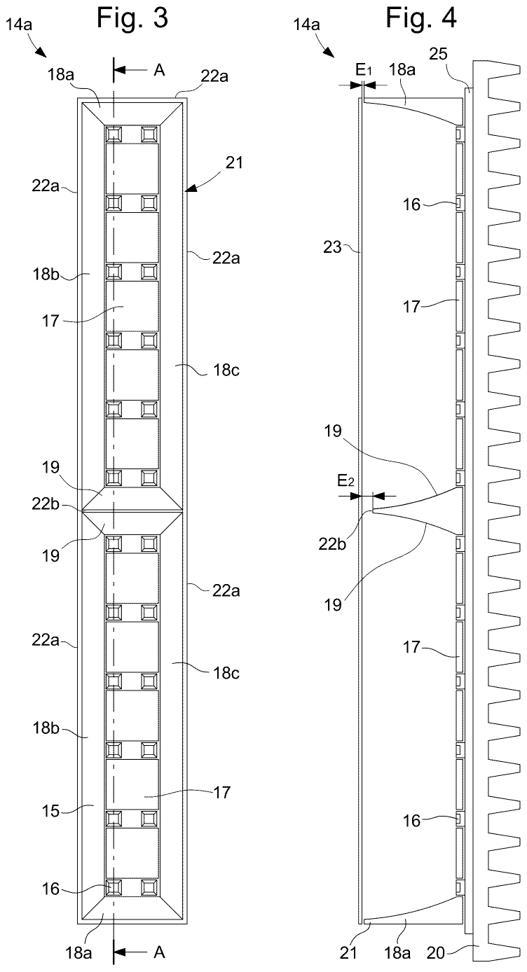

The main lighting module 14a, illustrated in FIGS. 3 and 4, can generate illumination specifically configured to reveal the characteristics of the precious stone 10. It should be recalled that this illumination corresponds to a luminous flux emitted by the main module 14a, which is received per surface unit by the zone of interest 8 and in particular by the precious stone 10. This illumination depends on the luminous intensity and on the distance of the main module 14a from the zone of interest 8 and accordingly from the precious stone 10.

This main lighting module 14a comprises:
a plurality of light sources 16 each designed to generate a light beam;
an optical diffusion element arranged facing this plurality of light sources 16, and
a reflector 21 comprising one or more cavities capable of reflecting one of the light beams towards the optical diffusion element, comprising a back 17, peripheral walls 18a, 18b, 18c, and a dividing wall 19.

More specifically, the main lighting module 14a comprises a circuit board 25 on which the light sources 16 are arranged. This module also comprises a heat sink 20 in contact with the circuit board 25. In particular, this heat sink makes it possible to dissipate the heat produced by the light sources 16.

In this context, the circuit board 25 is used to provide an electric current to the light sources 16. In this example, the light sources 16 are electroluminescent elements such as electroluminescent diodes. These light sources have adjustable colour temperatures that range between 2,500 K and 7,000 K, preferably between 5,700 K and 6,300 K, preferably of 6,000 K.

In this example, these light sources 16 are arranged on the circuit board 25 in rows and columns so as to form groups. In the example in FIGS. 3 and 4, twenty-four light sources 16 are thus arranged in two rows and twelve columns so as to form two groups of twelve light sources 16.

In this configuration, light sources 16 in the same group are generally closer to each other than to a light source in another group. As will be explained hereinafter, light sources 16 in the same group are characterised by the fact that they are associated with the same cavity.

In this main module 14a, the optical diffusion element 23 extends opposite the light sources 16 so as to be illuminated by them. This diffusion element is in the form of a plate that runs substantially parallel to the circuit board 25. It comprises two opposite faces: a rear face oriented towards the light sources 16 and a front face oriented towards the zone of interest 8. It has a thickness that is comprised between 2 mm and 8 mm, for example.

This optical diffusion element 23 is thus arranged so that its rear face receives, directly in this example, at least part of the light beams emitted by the light sources 16. In this example, “directly” is taken to mean that the light beams do not pass through any other optical element before reaching the rear face of this diffusion element. The light beams reflected by the reflector 21 are also assumed to reach this diffusion element “directly.”

While diffusing through this diffusion element, the light beams generate an extended secondary light beam on its front face, which makes it possible to illuminate the zone of interest 8. This diffusion element has diffusion angles, for a collimated beam arriving perpendicular to this diffusion element, which are comprised, for example, between 20 degrees and 140 degrees.

In this main module 14a, the reflector 21 is inserted between the circuit board 25 and the diffusion element, and therefore between the plurality of light sources 16 and this diffusion element.

The reflector 21 comprises walls, in this example peripheral walls 18a, 18b, 18c and a dividing wall 19 separating the two cavities. These walls form cavities around the light sources 16. As clearly shown in FIGS. 3 and 4, each cavity is formed around a single group of light sources 16.

More specifically, each cavity is formed around the plurality of light sources 16 so as to enhance the uniformity of the secondary light beam, while keeping the cavities to a sufficient size to effectively make use of their reflector effect 21. In this embodiment, this plurality is composed of twelve light sources 16.

To guide the light beams towards the diffusion element, the cavities are flared in the direction in which they widen from the light sources 16 towards this diffusion element. To guide the light beams towards this diffusion element, the walls around the cavities are reflective. In this example, the reflector 21 is made of a plastic material on which a thin metallic layer is deposited, such as aluminium, silver or a plating comprising a paint. As a variant, the reflector 21 can be made entirely of metal. A metallic material on which a plating such as paint or metal plating can be deposited by chemical or physical deposition methods using the following non-exhaustive and non-limiting deposition technologies:
chemical vapour deposition (more commonly known by the acronym CVD);
atomic layer deposition (more commonly known by the acronym ALD), using, for example, the Plasma-ALD (P-ALD) or Thermal-ALD (T-ALD) methods;
molecular layer deposition (more commonly known by the acronym MLD);
deposition of a layer by cathodic sputtering (more commonly known as the “sputtering method”);
a combination of at least two of these types of layer deposition technology.

The walls are elevated between the circuit board 25 and the diffusion element, and therefore between the plurality of light sources 16 and this diffusion element. However, these walls are not in direct contact either with the circuit board 25 or with the light sources 16 to avoid any short-circuit. The fact that a cavity is formed “around” a group of light sources 16 should be taken to mean that it is fitted close to the latter while slightly overhanging the circuit board 25, for example by a distance comprised between 0.5 mm and 3 mm.

In this configuration, the upper end of a light source, opposite the circuit board 25, can still be located in the corresponding cavity. The cavities therefore have entry openings at which the light sources 16 are located.

The peripheral walls 18a, 18b, 18c surround the plurality of light sources 16, meaning that, when placed end to end, the peripheral walls 18a, 18b, 18c surround all the light sources 16 on the main module 14a. In other words, the peripheral walls 18a, 18b, 18c do not run between two light sources 16. In the examples shown in the figures, the peripheral walls 18a, 18b, 18c overhang a rectangular perimeter on the circuit board 25. In this example, the peripheral walls 18a, 18b and 18c surround all the light sources 16.

On the other hand, the dividing wall 19 runs between the light sources 16. This dividing wall 19 runs more specifically between the two adjacent groups of light sources 16, that is, which are positioned side by side. In other words, the dividing wall 19 separates the two adjacent cavities. In this example, the dividing wall 19 runs from one peripheral wall 18a, 18b, 18c to another peripheral wall 18a, 18b, 18c.

It can be clearly seen in FIGS. 3 and 4 that the dividing wall is thus elevated in the middle of or inside the reflector 21, as opposed to the peripheral walls 18a, 18b, 18c, which are elevated at the periphery of the reflector 21.

The walls run from the back 17 of the cavity towards the optical diffusion element 23 with their respective tops 22a, 22b arranged relative to the optical diffusion element 23 at a first distance E1 for the peripheral walls 18a, 18b, 18c and a second distance E2 for the dividing wall, the first distance E1 being less than the second distance E2. In this configuration, the height of the peripheral walls 18a, 18b and 18c limits the amount of light that can escape before it reaches the diffusion element.

It should be noted that in one embodiment, in which the first distance E1 is zero, the rear face of the diffusion element is then in contact with the peripheral walls 18a, 18b, 18c. The light beams are then effectively confined inside the reflector 21, between the circuit board 25 and the diffusion element.

Thus, in general, the structure of the reflector 21 makes it possible to increase the compactness of the main lighting module 14a while producing a uniform secondary light beam to light the zone of interest 8. It also makes the main module 14a energy efficient since it increases the amount of light reaching the optical diffusion element 23.

A remarkable feature of the structure of the reflector 21, combined with the group arrangement of the light sources 16, is that a smaller number of light sources 16 can be used. In fact, the main module 14a is designed so that each light source generates a light beam illuminating a portion of the diffusion element.

As mentioned above, the device 2 also comprises the function setting module 5. In this respect, such functions relate to setting the illumination and temperature of the light sources 16 on the projector 3.

To set the illumination function, the module, via the processing unit and each electric motor, controls the movement of the projector 3 in a vertical and/or horizontal direction or controls the orientation of this projector 3. This module can also control the luminous intensity of the main module 14a.

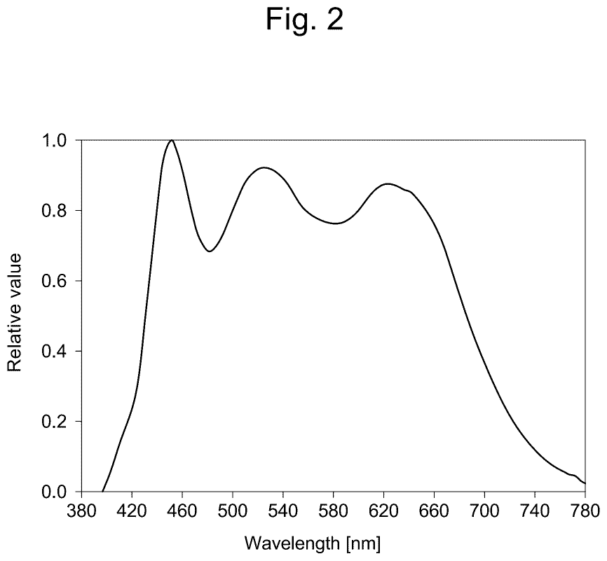

Referring now to FIG. 2, such a lighting device (2) makes it possible to diffuse uniform illumination of the zone of interest (8) over a light spectrum comprised between 390 nm and 780 nm. It should be noted that when conducting fluorescence tests, this lighting device 2 enables the diffusion of uniform illumination with a light spectrum comprised within a range of ultraviolet (UV) wavelengths of between 100 and 400 nanometres (nm). This spectrum is divided into three main sub-bands: UV-A (315-400 nm), UV-B (280-315 nm) and UV-C (100-280 nm). For a precious stone such as a diamond, exposure to such UV radiation results in the emission of fluorescent light, which can be of various colours. Most of the time the colour is blue. In fact, 98% of all diamonds with fluorescence will be of this colour. But there are other colours such as white, green, pink or yellow fluorescence. The colour of the fluorescence depends on the physical composition of the diamond's internal atomic structure.

Moreover, in this device 2, the secondary lighting modules 14b are preferably arranged in each lateral part of the projector 3. They are configured to attenuate the luminous disturbances that can result from a light source present in the work environment whenever the luminous intensity in this environment exceeds a predetermined threshold.

It is worth noting that such a lighting device 2 offers much better performance than the light boxes used to check the colour rendition of precious stones.

1. A device for illuminating a precious stone comprising:
a light projector equipped with a main lighting module for generating illumination specifically configured to reveal the characteristics of the precious stone,
said main module comprising a circuit board including a plurality of light sources each emitting a light beam and an optical diffusion element arranged facing said plurality of light sources, said main module comprising a reflector arranged between a support element and the optical diffusion element, said reflector comprising at least one cavity capable of reflecting at least part of the light beams towards the optical diffusion element, each cavity being formed by a back and peripheral walls extending from the back towards the optical diffusion element, with their respective tops arranged at a first distance from the optical diffusion element.

2. The device according to claim 1, wherein said reflector comprises two cavities capable of reflecting at least part of the light beams towards the optical diffusion element, each cavity being formed by the back, the peripheral walls and a dividing wall separating it from the other cavity, said walls extending from the back towards the optical diffusion element and having their respective tops arranged relative to the optical diffusion element at a first distance for the peripheral walls and a second distance for the dividing wall, the first distance being less than the second distance.

3. The device according to claim 1, wherein the light sources comprise electroluminescent elements.

4. The device according to claim 1, wherein the light sources have adjustable colour temperatures that range between 2,500 K and 7,000 K.

5. The device according to claim 1, further comprising a module for setting functions performed by the device, this module comprising an organ for controlling these functions and a screen transmitting information relating to these functions.

6. The device according to claim 1, further comprising a module for setting functions performed by the device, this module comprising an organ for controlling these functions and a screen transmitting information relating to these functions, said functions relating to setting the illumination and temperature of the light sources.

7. The device according to claim 1, further comprising an articulated arm comprising first and second parts connected at one of their two ends.

8. The device according to claim 1, further comprising an articulated arm comprising first and second parts connected at one of their two ends these first and second parts each comprising at least one motor for controlling the horizontal and/or vertical movement of the projector relative to said precious stone.

9. The device according to claim 1, further comprising secondary modules arranged in lateral parts of said projector and configured to attenuate luminous disturbances likely to result from a light source external to the device.

10. A system for testing the characteristics of a precious stone comprising the lighting device according to claim 1 and a support element to which is fastened said device which is configured to generate illumination of a zone of interest comprised on a plate on said support element, said zone of interest comprising said precious stone which can be handled by a user.
